(19) United States
(12) Patent Application Publication
(10) Pub. No.: US 2003/0006915 A1
(43) Pub. Date: Jan. 9, 2003

(54) Monitoring system and its use

(75) Inventors: Jarmo Kauppila, Eliaksentie (FI); Aki Lehikoinen, Itatuulentie (FI); Harri Mustonen, Kiulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Metso Paper Automation Oy

(21) Appl. No.: 10/228,014

(22) Filed: Aug. 26, 2002

Related U.S. Application Data
(63) Continuation of application No. PCT/FI01/00181, filed on Feb. 22, 2001.

(30) Foreign Application Priority Data
Feb. 28, 2000 (FI) 20000454

(51) Int. Cl. G03B 1/00

(52) U.S. Cl. 340/999; 396/661

(57) ABSTRACT

An on-line condition monitoring system for the real-time observation of a number of monitored objects comprises a sensor arranged at each object to generate signals representing the condition of the object, a substation for receiving signals from the object at certain measurement intervals and transmitting measurement data to a monitoring unit which has a processing unit and one or more workstations at which the condition of different objects can be observed, and a data network. The substation is further arranged to receive signals during a longer period from an object, which has been put into particular real-time observation. The substation and/or the workstation is arranged to process the signals received by the substation and to generate and present calculation results to the operator. The workstation is arranged by means of real-time signal analysis user interface software to display to the operator the measured signals and the results calculated from them.

### CROSS-REFERENCE TO RELATED APPLICATION

This application is a continuation of International Patent Application PCT/FI01/00181 filed Feb. 22, 2001, currently pending, which designated inter alia the United States and was published under PCT Article 21(2) in English.

### FIELD OF THE INVENTION

The present invention relates to an on-line condition monitoring system for monitoring the condition (e.g., vibration, temperature, pressure, flow, etc.) of several monitored objects such as devices or processes, and to the use of an on-line condition monitoring system.

### BACKGROUND OF THE INVENTION

A typical on-line condition monitoring system comprises at least one sensor or the like arranged at each monitored object in order to generate signals, which represent the condition of this object, and at least one substation, which is arranged to receive signals from one or more monitored objects at certain measurement intervals during a certain measurement period, which signals represent the condition of this object, and to transmit the so obtained measurement data generated by the measurements, i.e. said signals and/or results calculated from these signals in the substation, to the actual monitoring unit.

The actual monitoring unit of the monitoring system comprises

a processing unit, such as a separate server computer, for storing and/or for further processing the measurement data, i.e., the signals and/or the results calculated from them, which are obtained from said at least one substation during a certain measurement period, and

one or more workstations, at which the condition of different objects can be monitored on the basis of the measurement data stored in said processing unit. The monitoring system utilises a data network for transmitting the measurement data from the substation or substations to the monitoring unit.

Monitoring systems monitor the condition and the runnability of processes and devices, typically by measuring mechanical vibrations of the devices. For instance the wear or failures of devices cause vibrations in the devices. As measured quantities we can have for instance the acceleration, velocity or displacement. Condition monitoring further includes, depending on the object to be monitored, a number of other measurements, such as measurements concerning temperature, pressure, lubricant flow, rotation speed.

Typical objects to be monitored in industrial processes are among others gears, bearings, pumps, blowers, electrical motors, rolls, and turbine generators in power plants.

In industry distributed on-line condition monitoring systems are used to provide automatic monitoring so that the monitoring system detects a failure of a device or the like in its initial stage, and generates an alarm before the failure has time to develop so far that it will interfere with the production. The object is to prevent all unplanned shutdowns due to device failures by monitoring the condition of the devices and by anticipating the need for service before the actual failure, so that service and repair actions can be scheduled to take place simultaneously with planned service shutdowns.

In a distributed on-line condition monitoring system the actual measurement is made in so-called substations, which are connected to receive signals from the sensors at the monitored objects. The substations perform the required actions for converting the analogue signals into a digital form. In most cases the substations have also some calculation capacity, which can be used for the processing of the signals converted into a digital form. Then it is possible for instance to calculate from the signals different parameters and functions, which can characterise the condition and the runnability of the monitored object.

In addition to analogue sensor signals the substations can receive signals from pulse sensors, for instance from measurements of the rotation speed, which signals are used in so-called STA analyses (Synchronized Time Average analyses).

The substations can further have binary and analogue output channels, for instance for alarm or interlocking outputs to external systems.

For condition analysis different functions of the frequency domain, such as power spectra are calculated from the sensor signals by means of e.g. FFT technique (Fast Fourier Transform). From signals and time domain spectra it is possible to calculate different parameters, such as the peak value of the signal and RMS values of different frequency bands. In addition, it is possible to calculate parameters representing individual known malfunctions related to certain components, such as the parameters relating to the failure rate of bearing components.

Signal samples and/or already calculated results are typically stored at certain intervals in a database in the processing unit. The processing unit is typically a database server, i.e. a server computer with installed database software, such as a measurement database. The storing of the signal samples and the calculation results in the database is an essential part of the monitoring system, as it enables a follow-up of the changes occurring in the measurement results of a certain monitored object by means of history trends.

The data communication between the processing unit and a substation or substations takes place over a data network. If no particularly high requirements need to be set on the transmission rate, the network may be based for instance on a serial bus between the substations and the processing unit. A higher transmission rate is obtained by applying for instance a fast Ethernet-based local area network technique.

The operator of the condition monitoring system operates the system via a user interface, which is typically installed in a separate workstation. The information needed by the operator is transmitted from the processing unit to the workstation through the network. In small systems, where a separate workstation is unnecessary, the user interface software can be installed directly in the processing unit, whereby the processing unit operates as the workstation, but large systems require generally a number of separate workstations.

A typical industrial condition monitoring system has one processing unit, i.e. one database server. In very large systems the database can be distributed into a number of database servers, when desired. These systems have thus two or more processing units.

Condition monitoring systems measure and process signals having a frequency band, which typically extends up to several kHz. The frequency response of acceleration transducers commonly used for measuring mechanical vibrations extends for instance up to about 10 kHz. This means that the systems must be able to measure and process signals having a sampling frequency of up to several thousand or even tens of thousand samples per second. Therefore the performance of the systems cannot be dimensioned so that all signals from different sensors are measured and analysed continuously. The systems' I/O (Input/Output), calculation capacity and information storage capacity determine how often an individual monitored object can be measured and the results calculated from the measurements. In practice the systems measure a short sample from a certain monitored object, calculate the results needed, store them in a database, and perform an alarm handling on them. Then the system proceeds to measure and analyse the next object, and so on.

Thus the cycle time for the analysis of an individual object can range from a few minutes up to several hours. For instance, when monitoring bearings, a signal sample over a few seconds is measured for each monitored bearing, and the results needed are calculated from this sample. This is repeated regarding an individual bearing e.g. once every hour. Often such measurement period is sufficient, as typical bearing failures develop during a long time, and they can be readily detected, even if the measurement is made only once every hour.

However, in some cases a more detailed analysis is required to discover a defect. Therefore it must be possible to measure the signals with a high sampling frequency during long periods. This could be the case for instance for the analysis of a disturbance of the transient type. If we assume that the disturbance occurs randomly at intervals of a few minutes or even hours, it is very unlikely that we can get a sample thereof during the normal measurement cycle, if in a measurement cycle for instance only a sample of 3 seconds is measured every hour.

Therefore present-day condition monitoring utilises separate apparatuses for instance to analyse these disturbances, such as oscilloscopes or spectrum analysers, which apparatuses have been designed to monitor high-frequency signals in real time. These apparatuses are not fixedly connected to every monitored object, but the apparatuses are portable or otherwise mobile, and they are brought to the monitored object, when required. The signal to be examined is physically connected to the apparatus, whereby the apparatus is able to analyse the signal status continuously, for instance by outputting the actual signal to a display, or by continuously calculating parameters or functions from the signal. However, in practice this is inconvenient, as the use of a separate apparatus always requires the apparatus to be moved and to be physically connected to the signal cables of the monitored object. A large system can include several hundreds or thousands of measurements, and the signal I/O may be distributed all over the plant, over an area of many hectares. Then it is a very cumbersome task to find the coupling point, to bring the analyser to the coupling point, and to make the actual connections. Previously a real time analysis thus required a separate analysing equipment of its own, regardless of whether or not the monitored object belongs to an on-line condition monitoring system.

The object of the invention is to provide an improvement for performing a real-time signal analysis in a condition monitoring system.

Thus an object of the invention is particularly to provide a reliable and fast condition monitoring system, which can perform a real-time signal analysis.

### SUMMARY OF THE INVENTION

In order to attain the objects of the invention a condition monitoring system according to the invention and the use of a distributed on-line condition monitoring system are characterised in that there is further arranged for the real-time signal analysis:

measurement software in at least one substation, the software receiving from an object, which is placed under particular real-time monitoring, signals representing the condition of this object during a period, which is substantially longer than said certain measurement period,

calculation software in the substation and/or the workstation, which software processes the signals received by the measurement software in the substation and generates calculation results to be presented to the system operator, and

user interface software for real-time signal analysis in the workstation, which software displays to the operator the measured signals and the results calculated from them.

In addition, the system is typically linked to software in the substation and the user interface, the task of which software is to transmit data from the substation to the workstation and analysis control parameters from the workstation to the substation.

The solution according to the invention provides a possibility to utilise the existing distributed on-line monitoring system also for real-time signal analysis without separate analysers or other corresponding separate apparatuses. The solution according to the invention utilises the transmission capacity of the high-speed transmission networks of present-day condition monitoring systems, which capacity is sufficient for real-time transmission of data signals from the condition monitoring measurements made even at high sampling frequencies.

In a typical solution according to the invention a substation is provided with software, by means of which it can be set up to measure and process selected signals and to transmit measurement data as a continuous flow to the workstation. The measurement transmission utilises a high-speed transmission network between the substations and the workstations.

For instance in Ethernet-based networks the data transmission rate is typically 10 Mbit/s or 100 Mbit/s.

In a typical solution according to the invention the workstation of the condition monitoring system is provided with analysis software performing a real-time signal analysis, which software provides substantially the same functions as conventional stationary spectrum analysis equipment, such as continuous time domain scanning, STA analyses and spectrum calculation. In a solution according to the invention the measurement is always made in a substation, but the calculation of the analysis results, such as calculation of the FFT spectra, may be made alternatively in the workstation or in the substation.

When the analysis results are calculated in a substation the loading on the data transmission network and on the substation can be minimised, because the substation has only to perform the measurements, and it is not necessary to transmit the calculation results in the data network. On the other hand this requires that the processing power of the workstation is sufficient for real-time processing of the continuous data flow coming from the substation, and for a simultaneous visualisation of the measurement signals and the results calculated from them to the operator. Thus it is advantageous to perform the processing/analysis of the signals measured in the manner presented above either in the substation or in the workstation, depending on which is optimal for the performance of the system.

An advantage of the solution according to the invention compared to a conventional solution is that the real-time signal analysis does not require a separate mobile analyzer, but all functions are carried out by the existing components of the on-line condition monitoring system. The operator can couple by programme any selected signals to the realtime analyzer software located in the workstation, whereafter the operator can immediately begin to analyse the selected measurement objects. The selection of the object to be analysed does not require any connecting operations on the hardware level, but the operator can examine the selected measurements without leaving the worktable.

### BRIEF DESCRIPTION OF THE DRAWINGS

The invention is described more in detail below with reference to the enclosed drawings, in which

FIG. 1 shows schematically and as an example a part of the distributed on-line condition monitoring system, which is used for performing real-time signal analysis according to the invention, and

FIG. 2 shows an alternative solution regarding the network.

### DETAILED DESCRIPTION OF PREFERRED EMBODIMENTS

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

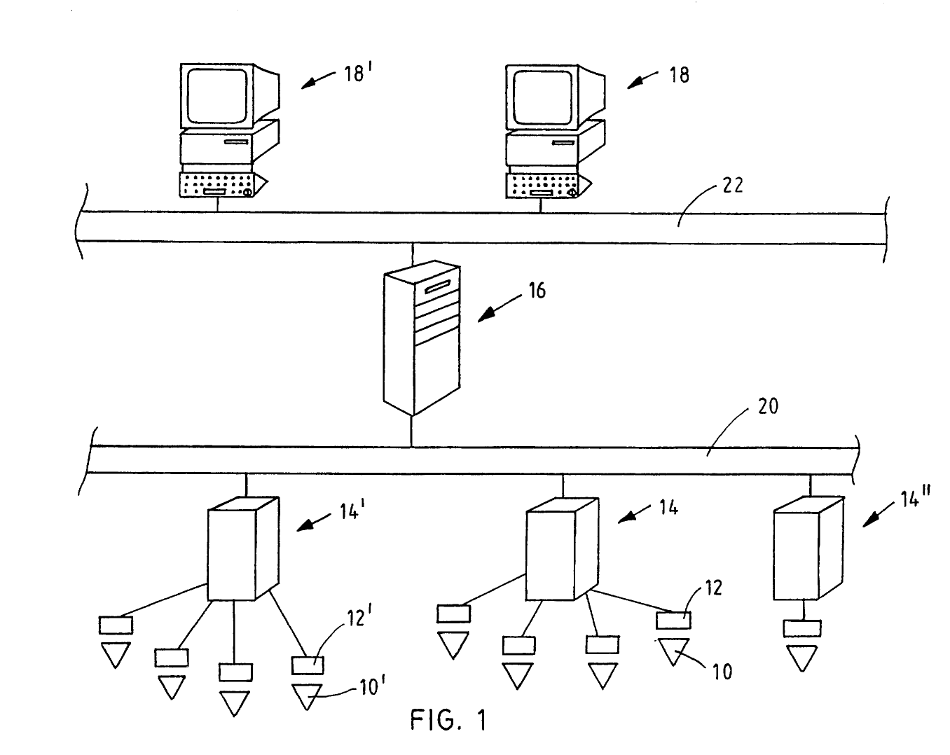

FIG. 1 shows a part of an on-line condition monitoring system, which is used to collect signals, which represent the condition of different devices 10, 10′ alternately at certain measurement cycles or intervals, and during certain relatively short periods. Sensors 12, 12′ are connected to the devices 10, 10′, such as sensors measuring the acceleration, velocity or displacement of vibrations, or temperature, pressure, flow, rotation speed. From each sensor the signals, which are measured during a relatively short period, typically only a few seconds, such as 1 to 10 seconds, are alternately supplied to the substation 14, 14′ of the condition monitoring system, and the substation converts the anlogue signals into a digital form. The substation can process the signals, if it has sufficient capacity. From these signals it is possible to calculate for instance different parameters and functions, which can characterise the condition of the measured object.

From the substations the digital signals and/or the calculated parameters or functions are transmitted as data to be stored in the processing unit 16, where the data can be examined via the workstations 18, 18′. The monitoring system comprises a data transmission network 20 for transmitting the measurement data from the substation 14, 14′ to the processing unit 16, and another data transmission network 22 for transmitting data from the processing unit 16 to the workstation 18, 18′.

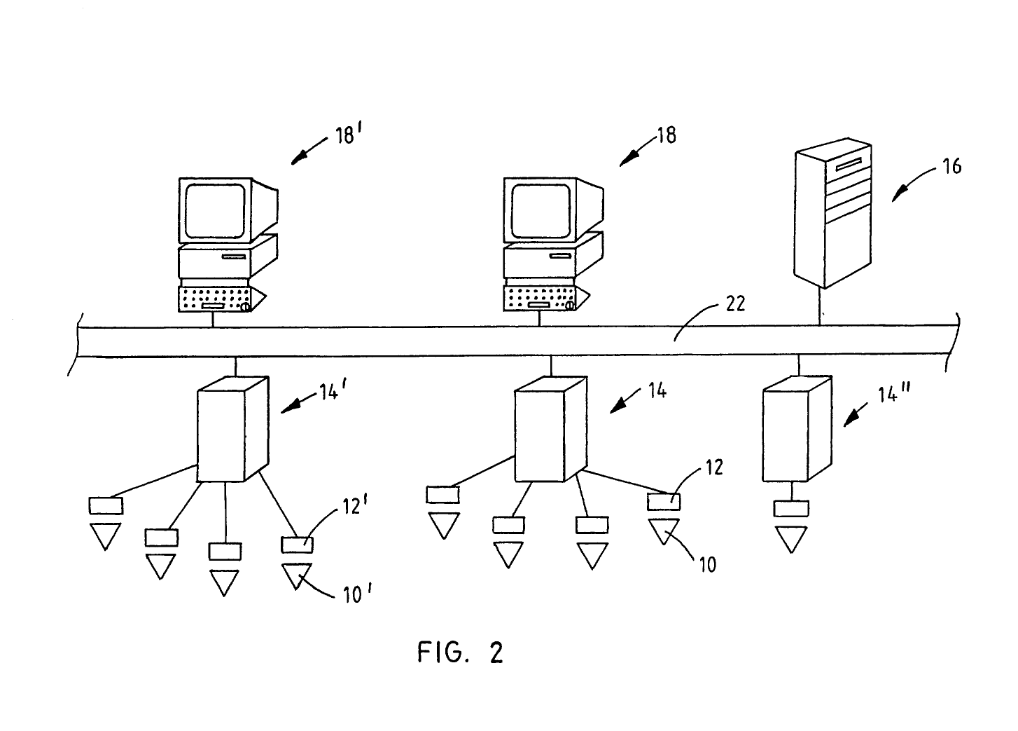

FIG. 1 shows a typical solution used in the industry, where the substations are connected to an own separate sub-network 20, whereas the workstations most often are directly connected to a factory network operating in the main trunk of the mill. Because the processing unit 16 communicates both with the substations and the workstations it must be connected to both networks, and when required, it can operate as a router in the direct data communication between the substations and the workstations. However, it is possible to construct the network in many different ways. For instance, the network solution can be such that the substations, the processing unit and the workstations are all connected directly to the factory network. A network solution of this type is presented in FIG. 2, which in other respects corresponds to the solution of FIG. 1.

According to the invention measurement software is arranged in at least one substation 14′, and by means of this software the substation can be arranged to receive signals representing the condition of an object 10′ which is under special observation during a period substantially longer than said certain short measurement period. The substation receives the analogue signals, which are continuous in time, and converts them into a digital form prior to further processing of the signals. In addition, the substation 14′ has been arranged to process the received signals, such as scaling and linearisation of the signals before they are transmitted to the monitoring unit.

The signals, which were converted into a digital form, are transmitted to the workstation 18′ for real-time signal analysis. According to the invention the workstation 18′ is provided with analysis software for performing the real-time signal analysis. Via the interactive user interface acting in the workstation 18′ the measurement program in a substation 14′ can be switched on in order to generate signals with the sensor 12′ from the object 10′. The continuous signals from the substation 14′ are then directed directly to the workstation 18′, where it is possible to perform the signal analysis and the visualisation of the results.

On the other hand it is also possible to increase the calculation capacity already at the substation 14′, so that this substation can perform a real-time signal analysis by using the analysis software, and transmit the calculated results to the workstation 18′ via the data network.

Sometimes vibration is monitored also on the basis of sound observations using a stethoscope or the like. In a system according to the invention the vibration signal measured at the examined object 10 can be correspondingly supplied to a speaker connected to the workstation, whereby the vibrations can be observed by hearing.

Thus the functions of the real-time analysis in the solution according to the invention can be distributed between the software of an intelligent substation, which performs the analysis calculations, and an intelligent user interface, so that the available resources can be utilised as evenly as possible in order to obtain a maximal speed in the analysis. The distribution increases the total processing power. This enables the use of versatile analysis tools in the real-time signal analysis. The real-time analysis according to the invention does not require any new cabling, but the analysis in question can be made for each point under constant monitoring, without any additional installation work.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for monitoring a plurality of monitored objects using an on-line condition monitoring system for the real-time observation of said monitored objects, the method comprising providing a condition monitoring system comprising:
at least one sensor arranged at each monitored object and operable to generate signals representing the condition of said object,
at least one substation operable to receive the signals from the sensor(s) of said one or more monitored objects at certain measurement intervals during a certain measurement period, which signals represent the condition of the monitored objects, so as to generate measurement data, and operable to transmit the measurement data to a monitoring unit,
a monitoring unit, which has
a processing unit for storing and/or for further processing the measurement data obtained from said at least one substation during a certain measurement period, and
one or more workstations at which the condition of the one or more monitored objects is observed on the basis of the measurement data stored in said processing unit, and
a data network for data transmission between the substation, the monitoring unit and the workstation,
the method further comprising:
performing real-time observation of at least one object using at least one substation operable by means of measurement software to receive signals from said object representing the condition of said object during a period that is substantially longer than said certain measurement period,
wherein at least one of said substation and a workstation uses calculation software to process the signals received by the measurement software in the substation so as to generate and present calculation results to the system operator, and
wherein a workstation is operable by means of real-time signal analysis user interface software to display to the operator the measured signals and the results calculated therefrom.

2. The method according to claim 1, wherein the substation is operable by means of the measurement software to transmit measurement signals and/or processed measurement signals to the monitoring unit, substantially at the same rate as the substation receives the measurement signals from a sensor sensing the monitored object.

3. The method according to claim 1, wherein the substation is operable by means of the measurement software to transmit measurement signals and/or processed measurement signals to the monitoring unit as a continuous data flow, the length of which the operator can define.

4. The method according to claim 1, wherein the substation is operable by means of the measurement software to transmit measurement signals and/or calculation results to the monitoring unit as a continuous data flow, wherein a frequency band of the signals in its maximum width extends up to a multiple of 10 kHz.

5. The method according to claim 1, wherein
the signals received by the measurement software in the substation are transmitted as a continuous flow to the workstation, and wherein
the workstation performs a real-time signal analysis calculation on the basis of the signals, which arrive as a continuous flow from the substation, the calculation comprising:
calculation of FFT spectra, and calculation of STA analysis (Synchronized Time Averaging analysis calculation),
calculation from time domain signals or from spectrum representations the RMS-values of the frequency bands, calculation of the signal's peak value, and calculation of parameters for failure rates,
and simultaneously the time domain planes of the signals and/or the results calculated from the signals are displayed.

6. The method according to claim 1, wherein
at least one substation performs a real-time signal analysis calculation on the basis of the signals received by the measurement software in the substation, the calculation comprising:
calculation of FFT spectra, and calculation of STA analysis (Synchronized Time Averaging analysis calculation),
calculation from time domain signals or from spectrum representations the RMS-values of the frequency bands, calculation of the signal's peak value, and calculation of parameters for failure rates,
and simultaneously the at least one substation displays the signals in the time domain and/or the results calculated from the signals, and wherein
the results of the signal analysis calculation are transmitted via the data network to the workstation where said results are displayed to the operator.

7. The method according to claim 1, wherein a substation transmits simultaneously to the workstation data received from one or more sensors.

8. The method according to claim 1, wherein the condition monitoring system is installed in an industrial plant, wherein the system is used to analyse the condition of gears, bearings, pumps, blowers, electrical motors, rolls, and/or turbine generators.

9. A monitoring system for the real-time observation of one or more monitored objects, the monitoring system comprising:
at least one sensor arranged at each monitored object and operable to generate signals representing the condition of said object,
at least one substation operable to receive the signals from the sensor(s) of the one or more monitored objects at certain measurement intervals during a certain measurement period, which signals represent the condition of the one or more monitored objects, so as to generate measurement data, and operable to transmit the measurement data to a monitoring unit,
a monitoring unit, which has
a processing unit for storing and/or for further processing the signals which are obtained from said at least one substation during different measurement periods, and
one or more workstations at which the condition of different objects can be observed on the basis of the measurement data stored in said processing unit, and
a data network for data transmission between the substation, the monitoring unit and the workstation,
wherein the monitoring system further comprises:
measurement software in at least one substation operable to receive from a monitored object, which has been put into particular real-time observation, signals representing the condition of the monitored object during a period that is substantially longer than said certain measurement period,
calculation software in at least one of a substation and a workstation operable to process the signals received by the measurement software in the substation and to generate calculation results, which are presented to the system operator, and
real-time signal analysis user interface software in a workstation operable to disply to the operator the measured signals and the results calculated from them.

10. A monitoring system according to claim 9, wherein the substation is operable by means of the measurement software to transmit measurement signals and/or processed measurement signals to the monitoring unit, substantially at the same rate as the substation receives the measurement signals from a sensor.

11. A monitoring system according to claim 9, wherein the substation is operable by means of the measurement software to transmit measurement signals and/or processed measurement signals to the monitoring unit as a continuous data flow, the length of which the operator can define.

12. A monitoring system according to claim 9, wherein the substation is operable by means of the measurement software to transmit measurement signals and/or calculation results to the monitoring unit as a continuous data flow, whereby a frequency band of the signals in its maximum width extends up to a multiple of 10 kHz.

13. A monitoring system according to claim 9, wherein
the measurement software in the substation is operable to transmit the received signals as a continuous flow from the substation to the workstation, and
the workstation is operable to perform a real-time signal analysis calculation on the basis of the signals, which arrive as a continuous flow from the substation, the calculation comprising:
calculation of FFT spectra, and calculation of STA analysis (Synchronized Time Averaging analysis calculation),
calculation of parameters from the time domain signals or from the spectrum representations, such as the calculation of the RMS-values of the frequency bands, calculation of the signal's peak value, and the calculation of parameters for failure rates, and the workstation is operable simultaneously to display the signals in the time domain and/or the results calculated from the signals.

14. A monitoring system according to claim 9, wherein
at least one substation is arranged to perform a real-time signal analysis calculation on the basis of the signals received by the measurement software in the substation, the calculation comprising:
calculation of FFT spectra, and calculation of STA analysis (Synchronized Time Averaging analysis calculation),
calculation of parameters from the time domain signals or from the spectrum representations, such as the calculation of the RMS-values of the frequency bands, calculation of the signal's peak value, and the calculation of parameters for failure rates, and wherein
the results of the signal analysis calculation are arranged to be transmitted via the data network to the workstation where they are displayed to the operator.

15. A monitoring system according to claim 9, wherein
a substation is arranged to transmit simultaneously with the aid of the measurement software data received from one or more sensors.

16. A monitoring system according to claim 9, wherein the condition monitoring system comprises sensors, which are mounted in the continuously monitored objects, the sensors being operable to measure at least one of acceleration, velocity, rotation speed, displacement, pressure, temperature, and flow of substances.

17. An on-line condition monitoring system according to claim 9 arranged in an industrial plant, wherein the system is arranged to analyse the condition of gears, bearings, pumps, blowers, electrical motors, rolls, and/or turbine generators.
